(19) United States
(12) Patent Application Publication
(10) Pub. No.: US 2007/0255814 A1
(43) Pub. Date: Nov. 1, 2007

(54) System for server consolidation and mobilization

(75) Inventors: Keith A. Green, Helotes, TX (US); Robert Fauteux, San Antonio, TX (US); Sam Trevino Sustaita, San Antonio, TX (US); Kelly J. Ross, Fair Oaks Ranch, TX (US); Robert S. Gagnon, Mansfield, TX (US)

Correspondence Address: Charles W. Hanor, P.C., PO Box 91319, San Antonio, TX, 78209, US

(73) Assignee: SECURETEK GROUP INC.

(21) Appl. No.: 11/412,652

(22) Filed: Apr. 27, 2006

(51) Int. Cl. G06F 15/173

(52) U.S. Cl. 709/223

(57) ABSTRACT

A system for consolidating multiple discrete machines and applications into a single rack mounted server system. Dedicated application servers maintain the discrete machines as virtual machines accessible by thin clients through secure hardwire or wireless connections and through client management servers. The system polls the application servers to compile lists of available and active applications. The list of available applications is displayed to users via an application navigation graphical user interface. The graphical user interface presents a menu from which users can point and click to select the application they wish to access.

### CROSS-REFERENCE TO RELATED APPLICATIONS

N/A

### STATEMENTS REGARDING FEDERALLY SPONSORED RESEARCH OR DEVELOPMENT

N/A

### REFERENCE TO A MICROFICHE APPENDIX

N/A

### BACKGROUND OF THE INVENTION

The present invention relates to networked computer environments comprising portable, secure, client/server relations; particularly, rack-mounted server systems operating multiple, complete virtual machines to which thin clients, or dumb terminals, and traditional “thick” clients can have access. This invention provides a system and method to consolidate legacy servers and a method for remote resource kiosking.

Rack mounted server systems have become common replacements for server farms. Rack systems save space by allowing numerous servers to occupy a single rack. The previous methods have consisted of large numbers of individual servers, often different hardware and operating system platforms, running different software. Unfortunately, such systems require users who wish to access different applications to search the multiple server systems for the specific application that they wish to access. In addition, such server systems are not designed to be portable. Moreover, unique server configurations and compatibilities make scalability such systems burdensome. The disadvantages of previous systems are overcome by and through the current invention.

Devine et al., U.S. Pat. No. 6,397,242 B1, discloses and describes a virtual machine monitor (VMM) and a virtual machine (VM) that operates a virtual processor. The VM functions as if it were a complete operating system with its own dedicated hardware. However, the VM has no dedicated hardware and is operable through the VMM on any hardware architecture through directly-executed instruction or binary translation. The VMM can directly execute the received instructions from the VM through the actual hardware, if compatible. Or, if the instructions from the VM are not compatible with the hardware through which the request must be processed, the VMM translates the instructions, through binary translation, so that the specific hardware may execute the instructions. The direct execution-binary translation dichotomy allows any program to be operated on any physical architecture. This patent is incorporated herein by specific reference thereto as the current invention virtualizes legacy and current machines so that they are available through the established network to the end user clients.

The current invention also takes advantage of virtual local area network (VLAN) technology such that the computers on the logically-independent network can act as if they are connected to the switch through the same port regardless of when and where the actual physical computer is moved without having to reconfigure any hardware. Chan et al. disclose such a system of virtual network connections in U.S. Pat. No. 4,823,338, which is incorporated herein specifically by reference thereto.

End users may access the network established by the current invention through thin clients. Richardson, in U.S. Pat. No. 5,748,892, discloses and describes one method and apparatus for managing clients with limited memory. The invention may utilize thin clients, but can be accessed by tradition, “thick” clients with complete memory and hard disk. However, the thin clients preferred are little more than graphics cards with incorporated keyboard and display. The thin clients access the homogeneous server package through any of the known secure means of network connectivity, including a secure satellite link. When the thin client is powered down, all memory caches and buffers are flushed such that if the client is lost there remains no recoverable data. This is an added level of security management present in the current invention.

### BRIEF SUMMARY OF THE INVENTION

The current invention provides a system for rapid deployment of portable, homogeneous server, which provides for flexibility due to the homogeneity of the individual servers and scalability due to the interconnectivity of the individual systems, for applications including military tactical, medical, logistical, and civilian arenas. The server system can be accessed through standard land-line, wireless, or satellite uplinks. Security is maintained through use of common access cards that identify individual users and security clearances. The network system provides a small footprint, a completely self-contained server stack with dimensions measuring about 21″×28″×33″, resulting in a highly mobile network capable of being moved quickly from place to place.

To further ease administration and to improve security, all applications are accessible via stateless thin-client workstations that are centrally managed within the homogeneous server package through the use of dedicated client servers, capable of being securely backed up on any of the other servers so as to maintain fail-safe operations.

For the reasons stated above, and for other reasons stated below that will become apparent to those skilled in the art upon reading and understanding the present specification, there is a need in the art highly mobile, securely accessible, and readily supportable network solution.

The preferred embodiment of this invention includes an application selection interface. The interface allows users to see a menu of available applications. Users can then quickly select an application to run from the menu. This is an important advance. Prior to this invention, users were unable to quickly discern what applications were available. With the present invention the available services are identified and presented via a java-based selector that allows easy point-and-click connections to any desired application. Likewise, when each thin client initially starts and registers with the client server it immediately displays the dynamically updated menu of all application available on all servers. With a mouse click, the end user selects the application from any of the servers and applications available, virtual or real, to run on that thin client. This makes choosing an application quick and easy while preventing frustrations associated with not being able to access applications that are not available but are still presented to the user in a “canned” or static environment.

One object of the invention is to displaying the exported kiosk applications on the thin clients via the customized application navigator GUI. Through this GUI, the user is presented with a dynamically updated list of available applications available (hosted on virtual machines running in the package) and can select which is displayed with a simple point and click of the mouse. From there, the user's display is connected, for example, via Windows-native rdesktop protocols to the application, and interaction commences just like the user was on a local machine running the application natively. Upon termination, the session is completely flushed, reset, and the application navigator GUI is redisplayed for the next application selection.

### BRIEF DESCRIPTION OF THE DRAWINGS

FIG. 1 illustrates how a plurality if discrete servers can be virtualized into a rack mounted server system, serving a plurality of thin clients.

FIG. 2A illustrates a front view of the homogeneous server package.

FIG. 2B illustrates a rear view of the homogeneous server package.

FIG. 3 illustrates the back of the SAN.

FIG. 4 illustrates the connectivity of the power distribution system.

FIG. 5 illustrates the application navigator GUI.

FIG. 6 illustrates the kiosk script flow.

FIG. 7 demonstrates the component connectivity to the power distribution system.

### DETAILED DESCRIPTION OF THE INVENTION

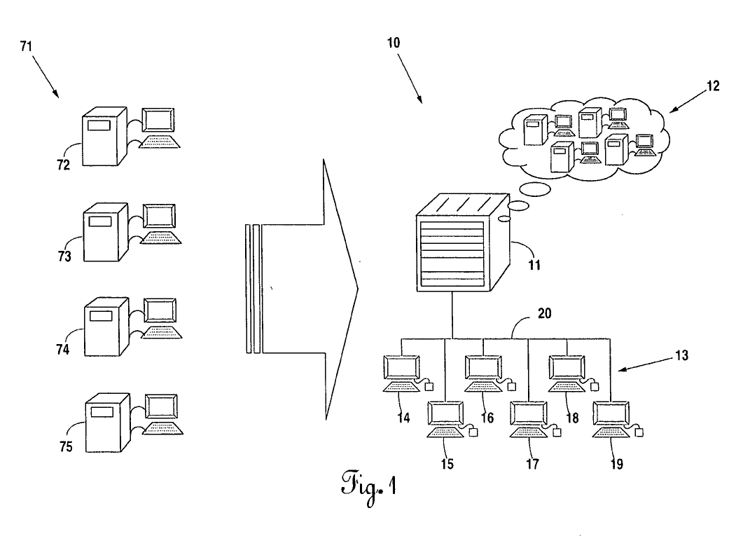

An embodiment of the invention is shown in the representation of FIG. 1. FIG. 1 demonstrates a low cost, rapidly deployable, light-weight miniature data center and network 10 that consolidates a heterogeneous group of real servers 71 into a single homogenous server package 11. In this depiction, the heterogeneous group of real servers 71 is understood to represent different computer systems that may be running different hardware architectures, operating systems and software. For example, legacy server 72 could represent a Hewlett-Packard machine running Microsoft Windows XP on an Intel x86 architecture. Legacy server 73 could be a Z-Micro machine running Microsoft Windows 2000 on an Intel x86 architecture. Legacy server 74 could be a Dell machine running a Linux Red-Hat operating system on an AMD Athlon architecture. Legacy server 75 could be an Apple machine running a Macintosh OS X operating System on an Intel Core Duo architecture. Other types of legacy servers could be main frame and mini-main frames running forms of Unix or proprietary operating systems. The group of real servers 71 can comprise any number of actual servers but is only represented as containing four systems for ease of representation and understanding. Through server consolidation technology, represented by the arrow in FIG. 1, the current invention does not require legacy servers or their applications to be reconfigured or migrated from their existing operating systems or software environments. The current invention exhibits a developed process and procedure to configure a master system that allows all of the legacy servers 72 through 75 of heterogeneous server group 71 to be represented and accessible to any number of users through homogeneous server package 11. The server consolidation technology herein described allows homogenous server package 11 to maintain a plurality of virtualized images 12 of each of the constituent legacy servers 72 through 75 of heterogeneous server group 71 to be available to users through network 20 via a plurality of client workstations 13. Such maintenance of the plurality of virtualized images 12 in homogeneous server package 11 and the granting of access to plurality of client workstations 13 through network 20 is known and understood in the art as described by Devine et al. in U.S. Pat. No. 6,397,242 B1, here incorporated by specific reference thereto. The homogeneous server package can host the plurality of client workstations 13, comprising any number of client workstations 14 through 19. Again, the plurality of client workstations 13 is represented as only comprising six client workstations 14 through 19, but the plurality of client workstations 13 may support any number of actual client workstations. Client workstations 14 through 19 can be traditional “thick” personal computers or laptops with full memory and disks connecting to homogeneous server package 11 through industry-standard Microsoft Windows-compatible remote rdesktop protocols. Or, client workstations 14 through 19 can be stateless thin client workstations that lack memory, disk, and operating system independent of the applications available on homogeneous server package 11. Client workstations 14 through 19 may take the form of portable laptop type computers. The client workstations 14 through 19 may be thin, stateless, dumb terminals that do not contain any substantial memory or a hard disk. Only a boot rom or removable media, such as thumb drives or compact-disk read only memory, may be provided. Or, client workstations 14 through 19 may be restricted based upon location so as to further protect sensitive data. Thin client workstations are known and understood in the art and described in such patents as Richardson, U.S. Pat. No. 5,748,892, incorporated here by specific reference thereto. Specifically, client workstations 14 through 19 may be Sun Ray stateless, ultra-thin virtual display clients model 170 available from Sun Microsystems, Inc.; however, plurality of client workstations 13 can comprise and homogeneous server package 11 can support both traditional “thick” clients and thin clients. Network 20 may be any secure network comprising any means of data transfer available including direct land line connections, wireless connections, or, secure satellite communications.

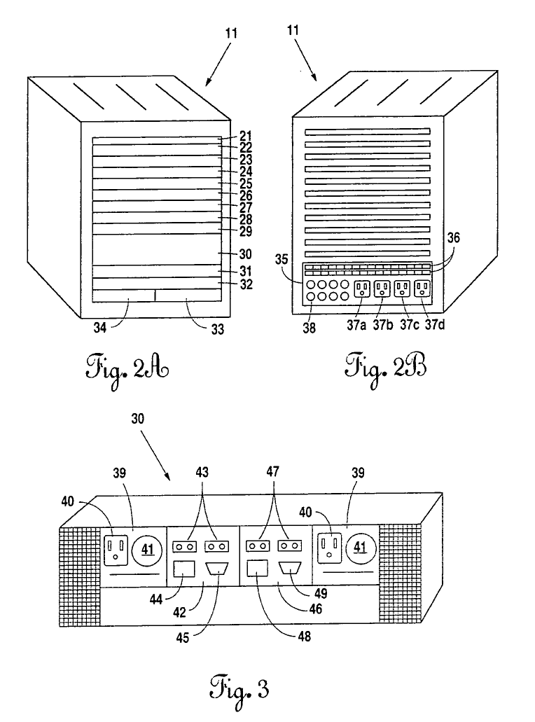

Referring to FIG. 2A, the hardware of the invention will be more specifically described. Viewing the front of homogeneous server package 11, the various components are visible, including a console and KVM tray 21. Console and KVM tray 21 provides direct control over the components of homogeneous server package 11. Console and KVM tray 21 may comprise a Tripplite Rackmount Keyboard/Monitor/KVM tray. The chassis of homogeneous server package 11, containing components 21 through 34, is selected to provide ruggedized transit and deployment housing for the commercial, off-the-shelf, equipment, which holds the components 21 through 34 with standard-spaced pre-drilled mount holes. The chassis of homogeneous server package 11 also provides mounts between the outer plastic shell and the mounting frame in order to reduce shock transfer to the internally mounted equipment. The chassis of homogeneous server package 11 may be military specification rated and includes handles (not shown) to aid in transport of such. Server blades 22 through 29 are separated into two groups: client servers, 22 and 23, and consolidated application servers, 24 through 29. The servers in each group may be of identical configuration and the configuration between each group is close enough to allow a server in one group to be easily repurposed as a server in the other group if the need should arise. In addition, the personality of each homogeneous server package 11 is determined by the make up and configuration of each of the servers and the task that they perform. Each homogeneous server package can be tailored to meet the requisites and demands of any task, such as minimizing weight for portability or increasing storage area 30 so as to hold more information.

To simplify management, all the servers may be from the same manufacturer. Each server blade 22 through 29 may comprise a SunFire X4100 Galaxy Server Blade with at least 2xAMD Opteron 275 dual-core processors, 16 GB RAM, a DVD-ROM, Q-Logic dual-channel fiber channel host bus adapters, rails and cable management arms, and with no internal hard drives. For redundancy and failover, there are two client servers, 22 and 23. The client servers hold the state of all clients in the environment and provide stateful failover in the event the primary client server should fail. The preferred embodiment of homogeneous server package may contain between three and six consolidated application servers, 24 through 29. Consolidated application servers 24 through 29 may have generic configurations so as to allow for rapid repurposing in the event that one physical piece of hardware is rendered unserviceable.

In the preferred embodiment, the two client servers, 22 and 23, may be configured as client servers running Sun Solaris with SunRay Server software. In this embodiment, the remaining consolidated application servers 24 through 29 may be loaded with VMWare ESX server and host the applications in virtual server “containers” that can be started, stopped, and relocated from server to server. Also, the management of the plurality of servers 22 through 29 may be handled via VMWare's Virtual Center and VMotion, normally running on the first blade of the consolidated application servers 24 through 29, specifically application server 24. The preferred embodiment further provides that during initial configuration and disaster recovery situations, the management center may be provisioned to run on client server 23 in a native-installation of Microsoft Windows XP.

Still referring to FIG. 2A, storage area 30 may contain all important data pertaining to the application environment. Particularly, storage area 30 may include all server image and configurations as well as the running images of all virtual servers and their applications. Storage area 30's functions to provide reliable, pervasive storage while facilitating rapid server failover in the event a problem arises. Since storage area 30 is available to all servers in the pack, client servers 22 and 23 and consolidated application servers 24 through 29, storage area 30 also facilitates the transfer of any one of the running virtual machines, represented as constituents of plurality of virtualized images 12 in FIG. 1, from server blade to another without having to shutdown the hosted application and restart it afterward. This operation and application mobility is a key advantage that provides the ability to load balance applications across homogeneous server package 11 or to relocate an application from any one of the plurality of servers 22 through 29 that is scheduled to be taken out of service for maintenance to any of the remaining operable servers of the plurality of servers 22 through 29 such that no mission-critical application is interrupted.

All random access storage may be handled in the central storage area 30, which may comprise a storage area network (SAN) array located in the center of the pack. In the preferred embodiment, all server blades 22 through 29 may be maintained in a non-persistent state condition, and can assume different roles based on the boot logical unit number (LUN) provided to them by storage area 30. Additionally, fail-over and redundant storage requirements are handled on a hardware level of storage area 30, thus reducing administrative overhead on the blade systems and increasing speed and efficiency. Storage area 30 demonstrates the overall effective break point between reliability, ruggedness, scalability, weight, and cost. In one embodiment, LC connections via Fiber channel is employed as the connection media due to its standard makeup in common off the shelf equipment combined with fast transmission capabilities. The client servers 22 through 29 may manage storage area 30, by running Sun StorEdge management software or similar management software. Storage area 30 contains two independent controllers (not shown), each with two Fiber-Channel LC ports (not shown) providing multipath and failover conduits to the SAN fabric switches 33 and 34. In that embodiment, each controller is connected to each SAN fabric switch 33 and 34, ensuring connectivity under all conditions of controller, storage area 30, or SAN fabric switch 33 or 34 failure.

As mentioned, homogeneous server package 11 may also contain two SAN fabric switches 33 and 34. For reliability and throughput, each server blade 22 through 29 may be connected to the SAN fabric switches 33 and 34 via dual paths, one to each storage switch 33 and 34. These connections help ensure connectivity under conditions of failure while providing multiple paths to and from storage area 30 for efficient 2 or 4 GBit/sec access. Additionally, two network switches 31 and 32 provide homogeneous server package 11 with the capability to network to outside networks and allow for the use of multiple homogeneous server packages 11 in conjunction with each other or outside networks. One configuration may comprise two identical, dual power supply Cisco Catalyst Ethernet switches 31 and 32 that are route capable. Interconnect ports are used to connect to external networks through external FC-AL connections, which may include other packs, special-use networks (i.e. the JNN), or the internet in general. Each switch may have 48 Gig-E ports, 4 SPF ports, and 2 switch interconnect (ICT) ports.

The connectivity of components is designed to provide optimum, reliable and redundant communications between all components of the homogeneous server package 11. Within the pack, virtual local area networks, or VLANs, are established to segregate traffic, minimize traffic density and chatter, and maintain consistency with existing network configurations. Such configurations are well known and understood in the art such as described by Chan et al. in U.S. Pat. No. 4,823,338, here incorporated by specific reference thereto.

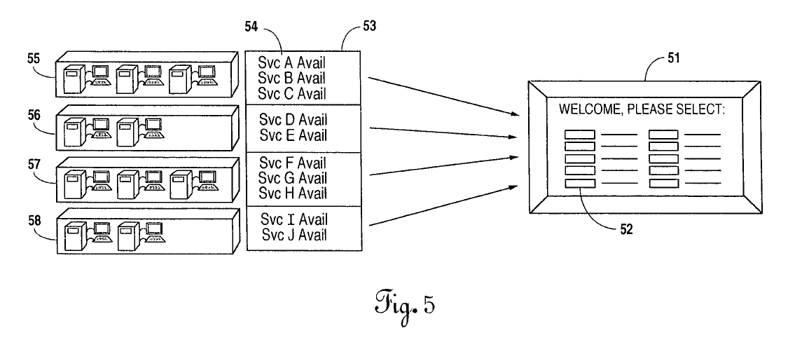

FIG. 2B depicts a rear view of homogeneous server package 11, which shows the power connections rear consolidation panel 35. Rear consolidation panel 35 allows for connectivity of the internal components of homogeneous server package 11 to the outside world or networks by providing multiple ports specifically for those purposes. Network connections 36 are bypass connectors that allow for outside networks or other homogeneous server packages 11 to connect and transmit and receive data from the internal network switches 31 and 32. Power busses 37a, 37b, 37c, and 37d are external connections to internal power distribution strips 50a, 50b, 50c, and 50d, respectively and shown in FIG. 4, which are arranged in a priority power distribution system described below. Connectors 38 are also connections to the external networks available to internal components, and may comprise LC-TFOCA connectors.

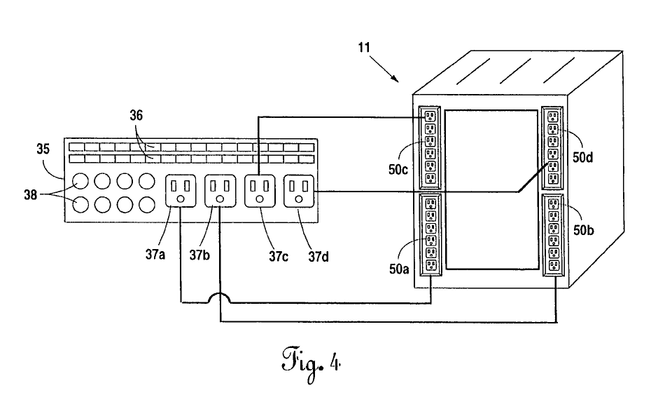

Referring to FIG. 3, the back of storage area 30 is shown and contains two independent controllers 42 and 46, each with two Fiber-Channel LC ports, 43 and 47, providing multipath and failover conduits to the SAN fabric switches 33 and 34, shown in FIG. 2A. Each controller, 42 and 46, is connected to each SAN fabric switch, 33 and 34, ensuring connectivity under all conditions of controller 42 or 46 or SAN fabric switch 33 or 34 failure. For reliability and throughput, each server blade 22 through 29, shown in FIG. 2A, is connected each SAN fabric switch 33 and 34 resulting in dual paths. This built in redundancy helps ensure connectivity under all conditions of controller 42 or 46, SAN fabric switch 33 or 34 failure, while providing multiple paths to and from the storage area 30 for efficient 2 or 4 GBit/sec access. The controllers' 42 and 46 network ports 44 and 48 are connected to the network switches 31 and 32, shown in FIG. 2A, for out-of-band management, and may be accomplished via Sun StorEdge management software running on the client servers 22 and 23. The serial ports 45 and 49 are not used in this configuration.

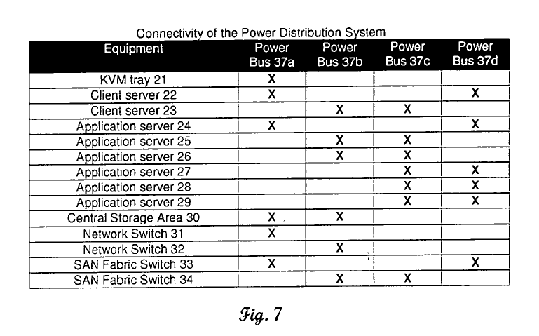

FIG. 4 illustrates a power distribution system used to supply the necessary electrical input to support the functionality of every component. The power distribution system may operate at 120V to 240V alternating current, 50 to 60 Hz, single phase power, with at least a maximum draw of 96 amps. No uninterrupted power supplies are provided for in the described embodiment of the current invention so as to decrease the overall weight and while increasing portability of homogeneous server package 11. However some type of uninterrupted power supply could be used. Also, power to homogeneous server package 11 is preconditioned externally so as to minimize deployable weight and reduce redundancy when preconditioned power is already provided for by the facility in which homogeneous server package 11 is installed. Power to homogeneous server package 11 is divided between four independent electrical busses, 37a, 37b, 37c, and 37d; each bus may draw up to 30 Amps. Electrical busses 37a, 37b, 37c, and 37d are arranged in a priority system, as illustrated explicitly in FIG. 7, and the power system is connected such that components draw power only when the resources are needed. In this described embodiment, pack-critical components, such as storage area 30 and console and KVM tray 21, may be operated on a reduced power load through electrical bus 37a, which is the highest priority bus. As additional components of homogeneous server package 11 are needed, for example increased need for use of application servers 25 and 26, additional busses become powered to support such needs. Power distribution is provided through four power distribution strips 50a, 50b, 50c, and 50d, each mounted on the inside of homogeneous server package 11. Electrical bus 37a is connected to and powers distribution strip 50a, and is of highest priority. Electrical bus 37b is connected to and powers distribution strip 50b, and is of second highest priority. Electrical bus 37c is connected to and powers distribution strip 50c, and is of third highest priority. Electrical bus 37d is connected to and powers distribution strip 50d, and is of lowest priority. The activity of the lower priority electrical busses 37b, 37c, and 37d is determined by the needs of the users of homogeneous server package 11.

FIG. 7 shows the electrical connection matrix and further shows the priority of electrical busses 37a, 37b, 37c, and 37d. The highest priority electrical bus 37a and power distribution strip 50a support console and KVM tray 21, client server blade 22, application server blade 24, storage area 30, network switch 31, and SAN fabric switch 33. When needs be, second highest priority electrical bus 37b and power distribution strip 50b are activated and support with power client server blade 23, application server blades 25 and 26, storage area 30, network switch 32, and SAN fabric switch 34. When third priority electrical bus 37c and power distribution strip 50c are activated, they support client server 23, application servers 25, 26, 27, 28, and 29, and SAN fabric switch 34. Finally, when lowest priority electrical bus 37d and power distribution strip 50d are activated, they support and provide power to client server 22, application servers 24, 27, 28, and 29, and SAN fabric switch 33.

The server consolidation technology, represented as the arrow in FIG. 1, provides three primary functions: server virtualization, thin client services, and an application server interface.

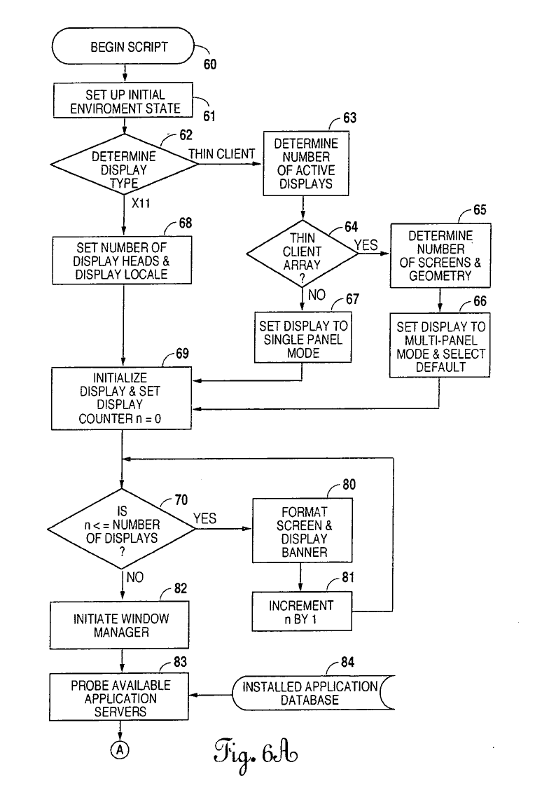

The server consolidation technology allows each physical server to function and appear as multiple, discrete machines in individual “containers,” as can be seen if FIG. 5. Application server 55 represents three discrete machines providing virtual applications 54A, 54B, and 54C. Each virtual application may run its own operating system, which is the same as that of the original operating system on which it runs on a real machine. These “guest operating systems” operate as if they have direct access to the original hardware architecture for which they were designed. Since the operating system of the original server or machine remains intact, the applications available to the clients through homogeneous server package 11 and the plurality of clients 13 do not require modification and will function normally. A description of overcoming the associated barriers to virtualization of machines is described in U.S. Pat. No. 6,397,242 B1 by Devine et al.

The preferred embodiment utilizes thin clients, which do not maintain any disk or memory space beyond that which is absolutely needed to start up and operate application selection interface 51, which also retain no data or information because all applications are running the application servers 24 through 29 through the client servers 22 and 23 and the plurality of clients 13. Client servers 22 and 23 provide a single point of administration for all clients, represented by the plurality of clients 13 in FIG. 1, and will allow any client to access any available application on any application server 24 through 29 regardless of from what client the user logs in, provided the user logs in with the appropriate credentials. The operating state of each application is maintained on the client servers 22 and 23 such that if a client workstation fails, the user may move to any other client workstation, identify themselves through the use of a common access card or CAC, and resume use of the application from where the user left off, with the same settings of the previous workstation down the personal settings. The CAC utilizes the same technology present in subscriber identity module (SIM) cards for global system for mobile communications (GSM) cellular phones.

FIG. 5 shows the application selection interface 51 presented to each user through the plurality of clients 13 (shown in FIG. 1). Ease of use is a key feature of homogeneous server package 11. FIG. 5 is only a representation of four application servers, 55, 56, 57, and 58, each hosting a plurality of applications 54, totaling ten in number; however, other numbers of application servers and applications may be used. As each application server 55, 56, 57, and 58 is started in its consolidated environment, it registers which applications are operational with the primary client server 53 and logs each application 54 as being “available”. The available services, 54A through 54J, are identified and presented to users via a java-based selector 51, which allows easy point-and-click connections through the user's selecting the presented application and clicking on its representation 52 in the java-based selector window 51. Likewise, when each thin client initially starts and registers with the thin client server it immediately displays the dynamically updated menu of all applications available on all servers. With a mouse click the end user selects the application to run through that thin client.

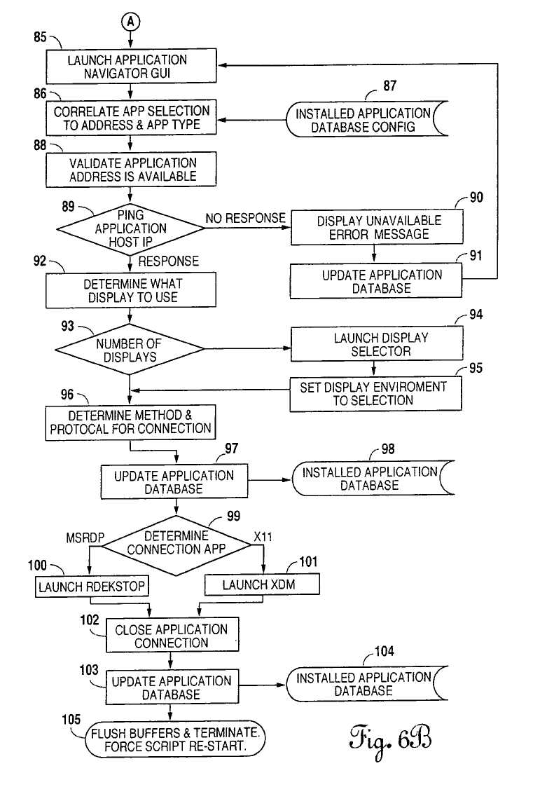

FIGS. 6A and 6B together illustrate a kiosking program flowchart which includes, in the preferred embodiment, the means by which the application selector graphical user interface is generated and kept current. Beginning in FIG. 6A, the script 60 is started and the program first sets up the initial environment state 61. Upon completion of that, the type of display type is next determined, whether it is a thin client or a thick client such as a machine running a Linux X11 operating system. If it is determined that a thin client is being used as in 62, the program then determines the number of active displays 63 and whether those active displays are acting as a thin client array 64. If it is determined that the thin clients are acting as an array 64, then the program then determines the number of screens and the geometry of such screens 65 and sets the display to multi-panel mode and selects default 66. If it is determined that the thin client is not acting as part of an array 64, then the display is set to single panel mode 67. If it was determined to be a thick client 62, the program then sets the number of display heads and displays the locale 68, meaning that the program detects the number and locations of users. Next, regardless of whether the display type was determined to be thick clients or thin 62 or thin clients in array 64, regardless of the display type, all displays are initialized and the display counter n 69 is set to equal zero. The next step if for the program to determine whether or not the display counter n less than or equal to the number of displays 70. If the display counter n is less than or equal to the number of displays, the screen is formatted and an informational banner is displayed 80, then the display counter n is incremented by 1. The loop 70, 80, and 81 may be repeated until the display counter n is greater than the number of displays. Upon determination that the display counter n is not less than or equal to the number of displays 70, the program then initiates the window manager 82. The program then probes the installed application database 84 for available application servers 83. The installed application database 84 contains information regarding users and security clearances as determined by the user's CAC.

Continuing on to FIG. 6B, through the kiosking program flowchart, the program launches the application navigator graphical user interface 85, which is displayed to the user of the client. Upon a user selecting and clicking an application, the program then correlates the application selection data to the specific address of the application and the type of application 86 by accessing the installed application database configuration 87. The program then continues to validate that the application address is available 88 through pinging the application host internet protocol address 89. If there is no response to the programs pinging of the application host's IP address 89, then the program displays an error message alerting the user that the application is unavailable 90, updates the application database 91 with the information that the selected application is no longer available and returns to launching the application navigator graphical user interface 85. However, if a response to the pining of the application host internet protocol address is received 89, then the program then determines what display to use 92. The program then determines the number of displays to use 93 by initiating the launch of a display selector 94, allowing the user to select the display environment and then setting the display environment to the user's selection 95. The program then determines the method and protocol for the how the connections 96 are established through either direct land line, wireless, or satellite uplink connections, or any other means of connection available in the art. The program then updates the application database 97 by sending information and actually updating the installed application database 98. Afterwards, the program determines the connection application 99, for example whether it is Microsoft Remote Desktop Protocol (MSRDP) or a Linux X11 graphics interface application. If the program determines that the connection application is the MSRDP 99, then the program launches rdesktop, an open source client for Windows NT Terminal. Or, if the program determines that the user is connecting to homogeneous server package 11 with a Linux-based system 99, the program launches XDM 101. Upon the user's finishing use of the application in homogeneous server package 11 or the user's manual termination of the use of the application, regardless of with which system the user logged in to the system, the program will next close the application connection 102. The program then updates the application database 103 to reflect in the installed application database that the user is no longer using that application 104. The program then flushes all memory buffers, terminates the script, and forces the script to restart 105.

One particularly useful deployment of the invention is for active military engagements that allow users at a remote locate to access the multiple servers from a laptop or work station via a thin client connection. The portable system can be easily deployed almost anywhere because of its light weight and portability. Even if the remote laptop or work station is lost or captured, once the link with the server is disconnected, there is nothing on the remote laptop or work station for the enemy hostile forces to access. This would allow installation of the remote laptop or work station on a military vehicle to access multiple systems and not contain any classified information on the remote laptop or work station.

Although the foregoing specific details describe various preferred embodiments of this invention, persons reasonably skilled in the art will recognize that various changes may be made in the details of the method and apparatus of this invention without departing from the spirit and scope of the invention as defined in the appended claims. Therefore, it should be understood that, unless otherwise specified, this invention is not to be limited to the specific details shown and described herein.

We claim:

1. A system for connecting to multiple server computers with a client computer, comprising:
an application selection interface that allows users of a client computer to see a dynamically updated menu of all applications available from a plurality of applications on a plurality of different servers from which users can then quickly select an application to run on a system and for remote resource kiosking;
means for identifying and presenting the available applications via the application selection interface that allows easy connections to any of the desired available applications;
means for displaying the dynamically updated menu of all applications available on the multiple servers when each client initially starts and registers with a client server so a user can select to run any application available on any of the servers to make choosing an application quick and easy while preventing a user from accessing applications not available to the user.

2. The system of claim 1, wherein the multiple server computers comprise multiple virtual server computers.

3. The system of claim 1, wherein the multiple server computers comprise multiple virtual server computers on a portable, secure, client/server system.

4. The system of claim 1, wherein the multiple server computers comprise multiple server computers using different operating systems.

5. The system of claim 1, wherein the multiple server computers comprise multiple virtual server computers using different operating systems and different platforms.

6. The system of claim 1, wherein the graphical user interfaces associated with the clients are arranged in an array.

7. The system of claim 1, wherein different users are differentiated based upon identifying information.

8. The system of claim 1, wherein the multiple server computers comprise a system of consolidated legacy servers for remote kiosking.

9. The system of claim 7, wherein the system maintains an image of the state of each identified user's application on a client/server system operating multiple, complete virtual machines.

10. The system of claim 1, wherein application selection interface connects to networks within a portable, secure, client/server system operating multiple, complete virtual machines to support both intraconnectivity and interconnectivity of the portable, secure, client/server system.

11. A method for connecting to multiple server machines on a secure, client/server system with a plurality of clients, comprising:
detecting all applications running on multiple server computers for allowing a user of a client see a dynamically updated menu of all applications available on all servers through an application selection interface from which the user can then quickly select an application to run from a system of multiple computer servers;
identifying and presenting the available applications on the multiple servers via the application selection interface that allows connections to any of the desired available applications on the multiple server computers;
displaying the dynamically updated menu of all applications available on all servers when each client initially starts and registers with a client server so a user can select to run any application available on any of the servers to make choosing an application quick and easy while preventing a user from accessing applications available to the user.

12. The method of claim 11 wherein the steps of detecting, identifying and displaying are performed on multiple server computers that comprise multiple virtual server computers.

13. The method of claim 11 wherein the steps of detecting, identifying and displaying are performed on multiple server computers that comprise multiple virtual server computers on a portable, secure, client/server system.

14. The method of claim 11 wherein the steps of detecting, identifying and displaying are performed on multiple server computers that comprise multiple virtual server computers using different operating systems.

15. The method of claim 11 wherein the steps of detecting, identifying and displaying are performed on multiple server computers that comprise multiple virtual server computers using different operating systems and different platforms.

16. The method of claim 11 further comprising the step of arranging the graphical user interfaces associated with the clients in an array.

17. (canceled)

18. The method of claim 11 further comprising the step of consolidating a system of legacy servers for remote kiosking.

19. The method of claim 11 further comprising the step of maintaining an image of the state of each user's application on the portable, secure, client/server system operating multiple, complete virtual machines.

20. The method of claim 11 further comprising the step of operating virtual local area networks within the portable, secure, client/server system operating multiple, complete virtual machines to support both intraconnectivity and interconnectivity of the portable, secure, client/server system.

21. The method of claim 11 further comprising the step of making the client/server system portable to allow for moving of the system.
